(19) United States
(12) Patent Application Publication
(10) Pub. No.: US 2010/0199423 A1
(43) Pub. Date: Aug. 12, 2010

(54) DEVICE FOR MOVING A PERSON OF REDUCED MOBILITY

(76) Inventors: Patrick Kraemer, Freland (FR); Laurent Marconi, Freland (FR)

Correspondence Address: FASTH LAW OFFICES (ROLF FASTH), 26 PINECREST PLAZA, SUITE 2, SOUTHERN PINES, NC, 28387-4301, US

(21) Appl. No.: 12/678,573

(22) PCT Filed: Sep. 9, 2008
(86) PCT No.: PCT/FR08/01258

§ 371 Date: Mar. 30, 2010

(30) Foreign Application Priority Data
Sep. 18, 2007 (FR) 0706545

(51) Int. Cl. A61G 7/10

(52) U.S. Cl. 5/81.1 HS

(57) ABSTRACT

The device is for moving a person of reduced mobility, in particular to move a person between two horizontal supporting structures disposed close to one another. The device has at least one movement element formed by a horizontally planar base and a supporting element. It is possible to move the base in relation to the supporting element by combining a guiding device with a pulling and gripping device so that the base is moved rectilinearly between end positions defined by the front and rear edges of the supporting element (3) when the element is being held stationary under a vertical force. The supporting element is formed by a plate that has a lower surface that has at least one rectilinear longitudinal rail that is engageable with at least one corresponding groove provided on the upper wall of the base.

The present invention relates to a device for quickly changing the position of a person of reduced mobility. It relates in particular to a device designed to make it possible to change the position of this person, by moving the person between two horizontal supporting structures arranged close to one another, without necessarily being contiguous nor on the same plane, like for example from a bed onto a stretcher or vice-versa, or from a seat to a bed or vice-versa or by switching from a position where the person is lying on their back to one lying on their side.

Moving people who are ill or injured from one supporting element to another or on that same supporting element, for example in emergency situations or in a hospital, involves many constraints, due on the one hand to the situation of the person concerned, who is not able to move freely and on the other hand to the layout of the premises and the equipment.

Some people, such as third degree burns or serious accident victims, have injuries which mean that any knocks or rubbing must be avoided. Yet ambulance or hospital staff sometimes have to move people in very confined and unsuited spaces. What is more, the supporting elements accommodating the patient, even placed side by side, are not always at the same level. The space available on either side of a supporting element may also be limited.

The main difficulty therefore consists in moving the person smoothly, as quickly as is required by the circumstances, while avoiding any rubbing or uncontrolled slides. It may for example be a case of moving a person who is lying on their back to a position on their side, to give them care or a wash. It may also be necessary to move a person from a fixed bed to a movable bed or from a movable bed to ating table—or vice-versa—in connection with a surgical operation. Furthermore it may be a case of moving an injured person from a stretcher to a bed, or a person from a wheelchair to a bed or vice-versa.

Known techniques often require handling operations which may be uncomfortable or even painful for the person to be moved, due to rubbing, sliding and tipping movements which cannot be avoided to achieve the change in position.

Furthermore, current devices may cause the staff using them on a daily basis some discomfort or even more or less serious injuries due to repetitive and intense physical efforts, like for example when handling people of strong build. These same devices are often particularly bulky and are consequently difficult to transport. Some existing equipment is not handy and takes a certain amount of time to set up, even though the person might have to be moved immediately.

Know solutions from the prior art do not make it possible to provide a fully satisfactory answer to these various constraints. They particularly require the intervention of several people and/or a sizeable working area and require either a specific and fixed infrastructure or prior assembly operations.

Document EP 0 609 758 describes by way of an alternative a supporting element for the human body comprised of a plate one end of which is curved and the other fitted with a hooking orifice and of a bag with an opening in the middle. The plate is designed to be inserted in the bag until the plate's hooking orifice is brought into line with the opening of the bag, to allow a hook to be passed through, the movement of a patient lying on this supporting element being performed by means of a strap and suspension cords wound around winding fixed to a ceiling mounted structure.

Document JP1-201255 describes a device comprised of a seat surrounded by a flexible strip, the ends of which are connected to superposed rollers, which are mounted on a lateral winding structure which forms an integral part of the receiving supporting element. After having unwound the required length of strip, the patient is positioned on the seat and the strip is then wound in the opposite direct on to bring about the movement.

Document GB 2 399 282 describes a motorised chair, the seat of which can slide on one side to an inclined position, to help a person in the seated position to return to a bed located at a lower level. To perform the movement, the patient has to sit down on the specially equipped chair, then activate the motorised device controlling the seat as far as the desired position before letting themselves slide slowly on the receiving supporting element.

Document US 2002/0134902 describes a movement device to help a person in the sated position return to or leave a supporting element, this device comprising two lateral rails connected by end bars to form a frame, and a plate inserted permanently between the two rails to slide between the end bars. In order to perform the movement, the device is positioned between the A and B supporting elements, and the patient then has to sit on the plate which they then move themselves along rails whilst holding on to the frame.

This invention therefore proposes to overcome the various drawbacks outlined above by proposing a device which makes it possible to quickly and safely change the position of a person of reduced mobility, from one supporting element to another supporting element, or on the same supporting element.

The device according to the invention is characterised in that it comprises at least one movement element with a base forming a moving part accommodating the patient and a fixed part performing the movement.

The present invention will be more fully disclosed in the description given below of non-restrictive examples of embodiment, and with reference to the appended figure, in which:

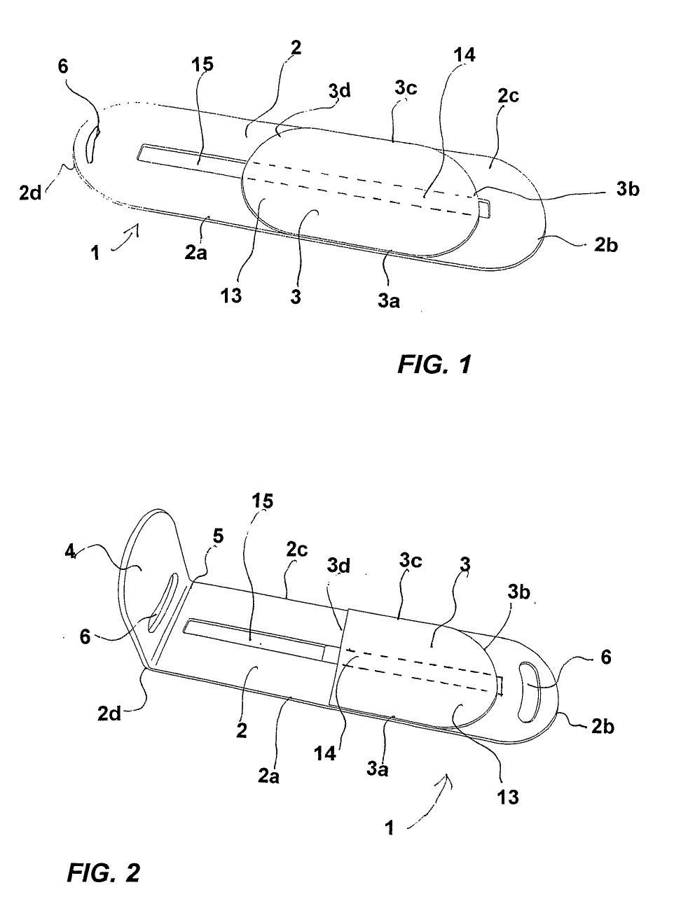

FIG. 1 is an elevation of a first embodiment of the movement device according to the invention,

FIG. 2 is an elevation of a second embodiment of the movement device according to the invention,

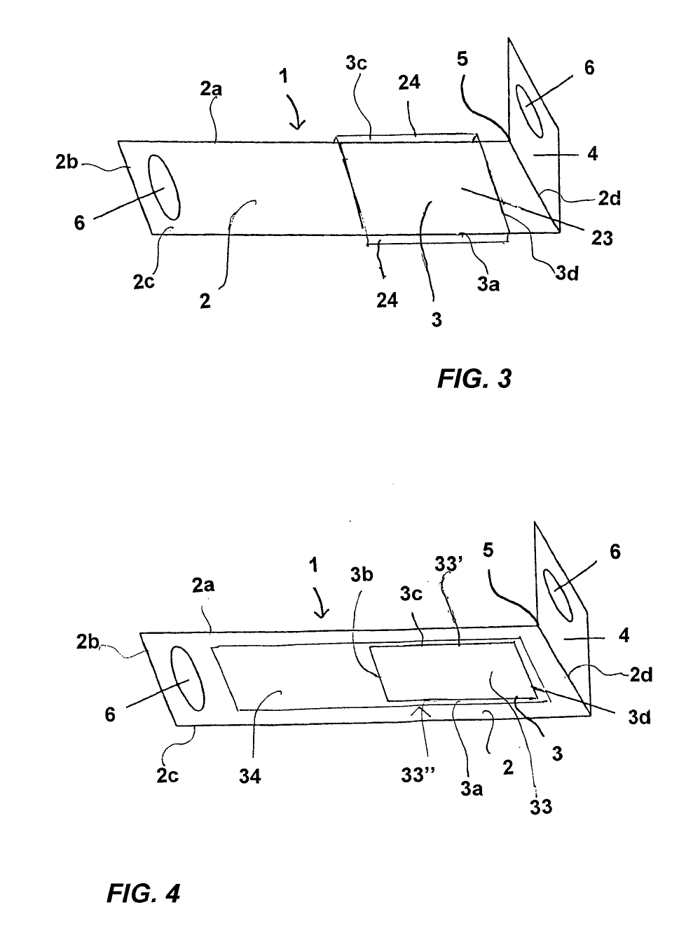

FIG. 3 is an elevation of a third embodiment of the movement device according to the invention,

FIG. 4 is an elevation of a fourth embodiment of the movement device according to the invention,

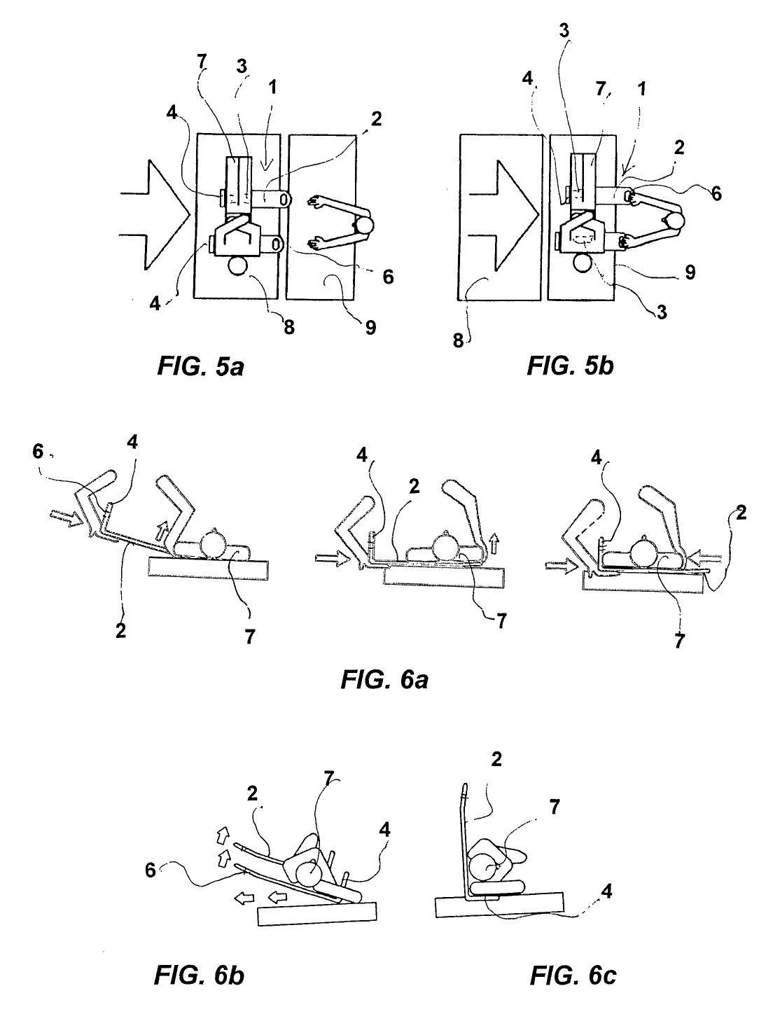

FIGS. 5a and 5b illustrate the phases where the device according to the invention is used to perform a movement of a supporting element towards another supporting element, and

FIGS. 6a to 6c illustrate the various phases where the device according to the invention is used to perform a lateral movement on the same supporting element,

With reference to the appended figures, and more particularly to FIGS. 1 to 4, the movement device according to the invention is comprised of at least one movement element (1) able to be made from any material, but preferably a smooth one.

More precisely, the movement element (1) is comprised of two distinct parts, i.e. a horizontally planar base (2) and a supporting element (3). The base (2) has two long sides (2a and 2c), respectively two short sides (2b and 2d), which are symmetrical. The long sides (2a and 2c) are rectilinear and define the lateral edges of the base (2). The short sides (2b and 2d) can be either rectilinear, or preferably rounded, and define the front and rear edges of the base.

The supporting element (3) also has four symmetrical sides, two of which (3a and 3c) at least are rectilinear and arranged parallel to the long sides (2a and 2c) of the base, to define the outer edges of the supporting element. The other two sides (3b and 3d), which define the front and rear edges of the supporting element, shall be able to be rectilinear, or, preferably rounded.

The base (2) and the supporting element (3) co-operate so as to allow the base (2) to move along its longitudinal axis, by following a rectilinear path between end positions defined by the front and rear edges of the supporting element (3) when the latter is kept fixed in position due to a vertical force, for example the weight exerted by a person.

For this purpose, the device (1) has means of moving the base (2) in relation to the supporting element (3) when the latter is in a fixed position.

The means of moving the base (2) in relation to the supporting element (3) combine guiding means with gripping and pulling means.

The base (2) comprises at least one end handle (6), formed by a piece cut out in the material and which constitutes the gripping and pulling means.

According to a first embodiment of the movement device according to the invention shown in FIG. 1, the supporting element (3) is made up of a plate (13) the to lower surface of which comprises at least one longitudinal rectilinear rail (14) designed to engage with at least one corresponding groove (15) on the upper wall of the base (2). The rail (14) and the groove (15) constitute guiding means. When the supporting element (3) is kept in a fixed position due to a vertical force, it is possible to slide the base along the rail (14) inserted in the groove (15) by pulling it by means of the handle (6).

Although in the example shown, the plate (13) of the supporting element (3) only has one single rail (14), it is however perfectly possible to provide two or more rails inserted in as many grooves on the base (2). For obvious reasons to do with balancing the forces and stress exerted on the plate when using the device, the rail (14), and therefore the groove (15) which corresponds to it, shall be arranged in a central position (in the case of a single rail), or symmetrically and at an equal distance from the edges (in the case of multiple rails).

According to a particularly advantageous alternative, shown in FIG. 2, the base (2) is connected to a stop (4) in a vertical plane by a fold (5) forming an angle α lying between 45 degrees and 135 degrees.

The fold (5) connecting the base (2) and the stop (4) can, but not necessarily, be made up of a flexible hinge or be formed by simply folding the material which is used to make the movement element (1).

The dimensions of the base (2) may vary in both length and width according to requirements, but the base (2) is preferably longer than the stop (4).

The stop (4) may at its end have gripping and pulling means similar to those described above, for example a handle (6¹), preferably formed by a cut-out in the material. In a preferential manner, the free ends of the base (2) and the stop (4) are rounded.

According to another possible embodiment shown in FIG. 3, the supporting element (3) is made up of a plate (23) the lateral edges (24) of which are folded back to be engaged by sliding along the long edges (2a and 2c) of the base (2). The plate (23) thus comes in the shape of a downwardly open sleeve, able to be engaged by sliding on the base (2).

According to another possible embodiment shown in FIG. 4, the supporting element (3) comes in the shape of a plate (33), preferably rectangular, the longest sides (33′, 33″) of which are inserted in a cut-out (34) formed in the base (2). According to this alternative, the cut-out (34) is carried out by the partial withdrawal of material on the upper surface of the base (2), allowing a bottom to remain. The cut-out (34) then comes in the shape of a hollow arranged in the body of the base (2), with a sufficient depth to allow the plate (33) to be inserted without the latter protruding above the base and without any space on either side, at the front and the rear. The outer surface of the upper wall of the supporting element (3) is thus located in the same plane as the upper wall of the base (2).

FIGS. 5a and 5b illustrate the phases for using the device according to the invention to perform a movement of a supporting element towards another supporting element.

In order to transfer the patient (7) from a first bed (8) to a second bed (9) arranged side by side, the operator slides the movement element (1) under the patient (7) to be moved, the latter coming to rest on the supporting element (3). The operator possibly proceeds in the same way to put in place a second, even several other movement elements identical to the first one (FIG. 5a). The operator then performs a pull, so that the base (2) is moved progressively by simply sliding towards a position opposite the position A (FIG. 5b). The patient resting on the supporting element (3) is then moved gently and smoothly thanks to the stops (4).

No other intervention is required, as this sliding will be performed by the simple action of the forces exerted, on the one hand by the weight of the person to be moved acting on the supporting element (3), and on the other hand by the pull carried out by the operator on the base (2) by means of the handles (6, 6′).

The patient is not subjected to any rubbing, as it is the base (2) which moves and not the supporting element (3) on which they are resting.

This provision greatly facilitates the use of the device to perform the movement of a person who is lying down or is seated, whilst limiting the risks of this person sliding or turning over, which can be important when it is essential to avoid any movement due for example to the patient's injuries.

Indeed due to the base (2) sliding under the supporting element (3), a minimal push will be sufficient to perform the movement. This is particularly appropriate, notably when the person to be moved is in a delicate position or when their significant weight is such that any movement generating rubbing would be difficult.

The cut-out (6) at the end of the base (2) makes it possible to slide and withdraw the movement device under a person without injuring or causing them discomfort.

The handles (6) at the end of the stops (4) make it possible to control the sliding, and if appropriate or necessary, exert a slight lifting movement, for example if the receiving supporting element is higher than the original supporting element.

FIGS. 6a to 6c illustrate the various phases involved in using the device according to the invention to perform a lateral movement on the same supporting element.

To change the lateral position of a patient lying down, the device (1) is put in place until the patient's side rests against the stop (4), as previously (FIG. 6a).

A slight pull is then exerted upwards by means of the handle (6) of the stop (4), to slightly raise the base (2) and perform the lateral tipping of the patient (FIG. 6b). The base (2) is then placed in its original horizontal position again before withdrawing the device (FIG. 6c).

The invention enables, if necessary, one operator to intervene alone.

Indeed, as soon as the person (7) to be moved in brought into the transfer position, all the operator has to do is move to the other side of the bed or the plane which the person lying down is in, to then exert a pull on the end of the base (2) and bring the person to be moved towards the new receiving plane, like for example a bed, a stretcher or an armchair, or to perform the lateral movement without changing supporting elements.

Withdrawing the movement elements once the movement has been completed is just as simple: as mentioned previously, a simple pull or push will result in the sliding movement in the direction of the base (2), the patient resting as mentioned previously on the supporting element (3). The withdrawal will then be greatly facilitated as there will only remain a small part of the base (2), made up of the area located between the end of the supporting element (3) and the end of the base (2), to be withdrawn to complete the movement operation.

In the same way, several movement elements (1) may be used, depending on the height of the patient or the size of planes A or B.

According to an advantageous embodiment, the supporting element (3) is movable and can be separated from the base (2) as the user chooses. This provision makes it possible to facilitate the maintenance of the device. It also enables the user to use the device in a simplified form, when the sliding function is not essential or available.

The preceding description makes it possible to appreciate the advantages of the device according to the invention. As they are preferably made of a smooth material, the movement elements (1) slide quickly on or under all types of surfaces and can thus be put in place under a person while avoiding painful areas.

The device makes it possible to move very heavy people without requiring any intense efforts. The pull exerted on the device will move the person by a sliding movement without the latter being subjected to any knocks, rubbing or painful handling. Likewise, the device is withdrawable without handling the patient on the receiving plane.

The device is compact, light and therefore easily transportable. Being comprised of several identical, therefore combinable elements, it is stowed away without any difficulty and does not take up much space. The device can be washed and disinfected quickly and without any difficulty. It does not required any special layout, be it in the rooms where it is used or on the receiving planes, for example the beds, stretchers or armchairs. It can be used immediately without any preparation or prior assembly.

Of course, the movement device according to the present invention is not restricted to the above-described embodiment and will be able to be varied in a number of ways within the scope of the invention as defined by the claims.

1. A device for moving a son of reduced mobility, comprising:
at least one movement element (1) formed by a horizontally planar base (2) and a supporting element (3), the base (2) having two longs sides (2a and 2c), respectively two short sides (2b and 2d), which are symmetrical, said long sides being rectilinear and defining the lateral edges of said base, and said short sides defining the front and rear edges of said base, and the supporting element (3) having four symmetrical sides (3a, 3b, 3c and 3d), at least two of which are rectilinear and arranged parallel to the long sides (2a and 2c) of the base to define the outer edges of said supporting element, the other two sides defining the front and rear edges of the supporting element, and
means for moving the base (2) in relation to the supporting element (3) combining guiding means with pulling and gripping means for performing the movement of the base (2) along a rectilinear path between end positions defined by the front and rear edges of the supporting element (3) when the supporting element is held in a fixed position by a vertical force.

2. The device according to claim 1, wherein the gripping and pulling means are made up of at least one handle (6) formed by one piece cut out in the material at the end of the base (2).

3. The device according to claim 1, wherein the supporting element (3) is detachable.

4. The device according to claim 1, wherein the supporting element (3) is made up of a plate (13) the inner surface of which comprises at least one rectilinear longitudinal rail (14) designed to engage with at least one corresponding groove (15) provided on the upper wall of the base (2).

5. The device according to claim 1, wherein the supporting element (3) is made up of a plate (23) the lateral edges (24) of which are folded back to be engaged by sliding along the long edges (2a and 2c) of the base (2).

6. The device according to claim 1, wherein the supporting element (3) is formed by a plate (33) the longest sides of which (33a, 33b) are inserted in a cut-out (34) formed by the partial withdrawal of material on the upper surface of the base (2).

7. The device according to claim 1, wherein the base (2) is connected by one of ends of the base to a stop (4) in a vertical plane by a fold (5) forming an angle (α) lying between 45 degrees an 135 degrees.

8. The device according to claim 8, wherein the fold (5) connecting the base (2) and the stop (4) is made up of a flexible hinge.
